(19) United States
(12) Patent Application Publication
(10) Pub. No.: US 2016/0048890 A1
(43) Pub. Date: Feb. 18, 2016

(54) Pet social network

(71) Applicant: Christopher Viale, Westfield, MA (US)

(72) Inventor: Christopher Viale, Westfield, MA (US)

(21) Appl. No.: 14/121,306

(22) Filed: Aug. 18, 2014

(51) Int. Cl. G06Q 30/02; A01K 29/00

(52) U.S. Cl. CPC G06Q 30/0277; A01K 29/00; G06Q 50/01

(57) ABSTRACT

A social network for pets comprising: a computer system wherein a user uploads photos and videos of a user's pets. The system further comprises images of advertiser's products and services related to pets. The system provides products comprising pet supplies and pet services.

### RELATED APPLICATIONS

This application is based on provisional patent application Ser. No. 61/959,170 filed on Aug. 16, 2013.

### FIELD OF THE INVENTION

The present invention relates to a social network for pets.

### BACKGROUND OF THE INVENTION

US patent publication 2013/0068173 relates to a system for remote interaction with a pet by a home computer connected to a movable turret. The turret has rotary components driven by servo motors to direct a laser to the floor to create shapes depending on the play to be performed. Video and audio including the pet owner's voice may be introduced to further entertain the pet while he or she is home alone.

US patent publication 2010/0204984 relates to a virtual pet system, method and apparatus for virtual pet chatting. A virtual pet system includes a virtual pet client, adapted to receive a sentence in natural language and send the sentence to a Q & A server; the Q & A server, adapted to receive the sentence, processes the sentence, and generates an answer, that is sent to the virtual pet client.

US patent publication 2008/0103784 relates to a method and system for generating an interactive computerized biological network consisting of living and non-living entities based on the multiple relationship types that can exist between entities. The network can consist of multiple node types. Such node types can include persons, places, objects and animals, each connected by one or more linkages associated with a precise linkage type representing the relationship type between a node and any other node type in the same network. Nodes are connected to other nodes in the network by linkages which can have multiple linkage types. Each linkage type represents the actual relationship type between the nodes, such as person, place, object or animal represented by the nodes.

US patent publication 2013/0073299 relates to a caregiving social network. A server implements a caregiving social network dedicated to coordinating care between caregivers and care recipients. Profile information is recorded to assist in coordinating care, as well as targeting advertising and information material that is highly relevant to an individual user and his community. Users of caregiving social network include, seniors, disabled people, children, parents, volunteers, medical professionals, neighbors, military families and pets. Users can maintain both a caregiver account to assist others, and a care recipient account for receiving assistance.

US patent publication 2008/0172381 relates to a method and system for connecting service providers with service requesters within a social network. The system and method may operate for no compensation for service requester. The system and method may be based on user feedback and/or a point system. The system and method may be applied to a social network for connecting pet owners with pet sitters for provision of pet sitting services.

US patent publication 2008/0091556 relates to a web-based communication tool for pet owners. The system and method is directed to interactive communication for associated pet owners. Selection data inclusive of attraction data is first received from multiple pet owners. Selection data with respect to the multiple associated pet owners, is associated with at least one attraction module. In one embodiment, the attraction module is selected from the group consisting of meeting friends, pet advice, veterinarian answers, memorial, postings, weekly pet horoscopes, pet fashions for sale, pets in news, and hero of the week. Next, a user interface is generated in accordance with the performed association, and displayed to the multiple pet owners. Interaction is then accomplished between the multiple associated pet owners via the user interface from remote locations.

Social networking sites have become engrained in people's daily lives. They allow the users to share their personal lives and engage with friends, family, coworkers and strangers. People can share aspects of their lives, their thoughts, what they are wearing, where they are shopping, what they ate for lunch, what their plans are for the weekend, and everything in between.

Many social media users have created profiles of their pets. There are birthday wishes, status updates and pictures posted.

### SUMMARY OF THE INVENTION

The present invention is a social media site that caters to pet owners. The present invention provides a place where pet owners can showcase their pets and at the same time expose the users to advertiser's products and services related to their pets.

It is an object of the present invention to comprise a computer system comprising an animated site. It is an object of the present invention for a user to post texts, photos, videos, stories about their pets, share web links, share videos from other sites, upload and share videos and/or reply to comments.

It is an object of the present invention to comprise a computer system that has a site to provide pet supplies to the users.

It is an object of the present invention for the site to have a virtual city, having virtual buildings. It is an object of the present invention for a user to make a trip to the virtual city by logging onto the site. It is an object of the present invention for the user to explore the various buildings.

It is an object of the present invention for the user to shop for pet supplies on the site. It is an object of the present invention for the site to have a veterinarian clinic that provides advice for users, provides medications, and provides referrals to veterinarians in their area.

It is an object of the present invention for the system to have a shelter where a user adopts a pet.

It is an object of the present invention for the system to provide charitable institutions for users to donate to an animal charity.

It is an object of the present invention for users to visit other pet owners in one of the many housing units in the system. It is an object of the present invention for these units to house pet owners of dogs, cats, horses, or fish for example. It is an object of the present invention for the dog housing unit to be a virtual dog house. It is an object of the present invention for the horse housing unit to be virtual stables. It is an object of the present invention for the fish housing unit to be in a pond.

It is an object of the present invention for each of the virtual housing units to have a virtual lobby to serve as a central gathering place for all pets within a particular class. It is an object of the present invention to provide on the site a bulletin board where all of the users can see what all of their pets are up to.

It is an object of the present invention to have a virtual mayor or mascot on the site to assist a user in registration for the site, or finding anything on the site.

It is an object of the present invention for the system to allow users to vote for different positions on the site, such as, mayors, or mascots. It is an object of the present invention for the system to provide a way for users to vote on new functionality for the system.

It is an object of the present invention for the system to have its own dictionary of terms and phrases unique to the system. It is an object of the present invention for the system to engage with the users in suggesting words for the site dictionary.

It is an object of the present invention for the system to provide to users a daily, weekly, monthly and annual contests. It is an object of the present invention for the system to have holiday themed contests. It is an object of the present invention for winners of the contests to be paid in a currency that is spent on the site. It is an object of the present invention for the currency to be spent at a mall on the site, or donated to one of the charities on the site.

It is an object of the present invention to create a virtual one stop shop for things having to do with pets.

It is an object of the present invention to provide to a user a way to purchase pet insurance on the site. It is an object of the present invention to provide to a user a way to purchase pet food on the site.

It is an object of the present invention for the system to have a method for registering for the site, including a password.

It is an object of the present invention for the user to create a profile for the site.

It is an object of the present invention for the system to walk the user through the registration process, giving screen tips/hints as necessary. It is an object of the present invention for a caricature of an actual pet to provide the screen tips/hints. It is an object of the present invention for the users of the system to vote on the caricature.

It is an object of the present invention for the user to choose a pet type/residence. It is an object of the present invention for the user to enter pet information into the system. The user will have to enter a human email address and other basic information into the system.

It is an object of the present invention for the user to enter the breed of the animal if applicable into the system.

It is an object of the present invention for the user to enter the pet's birthday into the system.

It is an object of the present invention for the user to upload a profile picture of the pet into the system.

It is an object of the present invention for the user to update detailed profile information about their pet, including, favorite food, favorite toy, favorite collar, favorite activity or hobby. It is an object of the present invention for the system to use this information to provide directed marketing to the users.

It is an object of the present invention for the system to provide an agreement of acceptable terms to the user, that the user must agree to before the user is allowed on the site.

It is an object of the present invention that upon registration, the user is brought to the main page of the site. At the main page a user can do a variety of things throughout the city (site). It is an object of the present invention for the site to feature a virtual city with virtual buildings and stores. It is an object of the present invention for the site to have a news feed. It is an object of the present invention for the news feed to include announcements and news articles displayed for all of the users. It is an object of the present invention for the announcements to also include contest announcements, and winners. It is an object of the present invention for the announcements to comprise advertisements. It is an object of the present invention for the announcements to comprise voting instructions.

It is an object of the present invention for the system to display the posts from the user's pet friends on the announcements, or on a bulletin board for each residential building.

It is an object of the present invention to have a residential building for each pet. It is an object of the present invention for the buildings to be pet specific. It is an object of the present invention for the buildings to be for dogs, cats, birds, horses, fish, lizards, snakes and rodents.

It is an object of the present invention for the system to provide buildings which have a split screen that show their own room and the lobby of the building. It is an object of the present invention for the room to look like an actual room in an apartment complex. It is an object of the present invention for the user to customize the room with their own pictures, wall colors and other personal items.

It is an object of the present invention for the lobby of the building to feature a directory of users and show which of the users are online. It is an object of the present invention for the system to show a list of the user's friends and whether they are online.

It is an object of the present invention for the system to have a bulletin board that allows users to interact with other residents of that building through status posts, picture posts, and comments. This is the main communications hub for each residential building.

It is an object of the present invention for the system to have a virtual mall that operates as a main sales page of the site. It is an object of the virtual mall to have a design that imitates an actual mall with store fronts and a directory of shops that are located throughout the mall. It is an object of the present invention for the mall to display advertisements. It is an object of the present invention for the mall to list categories and products. It is an object of the present invention for the system to provide a user a way to buy products and/or services that are listed in the virtual mall.

It is an object of the present invention for the system to have a doctor's office where users can visit to find veterinarians, order medications, or find advice on problems that a user's pet may be having.

It is an object of the present invention of the system to have a virtual shelter where a user can adopt a pet or donate to their favorite pet charity. It is an object of the present invention for the system within the shelter to list all available adoptions of pets. It is an object of the present invention for the system to provide a user a way to filter through the adoption list, by, for example, pet type, breed, etc. It is an object of the present invention for a user to submit an adoption request for a specific pet within the shelter.

It is an object of the present invention for the system to have a virtual stadium which comprises the contest section of the site. It is an object of the present invention for the system to provide a moving virtual blimp where advertisers can display ads, and users can enter a variety of picture and video contests.

It is an object of the present invention for the system to provide money that is either spent in the mall or donated to their favorite charity. It is an object of the present invention to keep users engaged and to give them incentives to enter the mall and spend.

It is an object of the present invention for the main page of the website to display all banner ads for the systems advertisers.

It is an object of the present invention for the system to have a place where a user registers to run for mayor when it is election time and also serves as an oversight area for the site. It is an object of the present invention for the system to allow users to report inappropriate conduct, and ask questions.

It is an object of the present invention for the system to have an area where breeders from around the country advertise pets they have for sale, and include information about the animals credentials, awards, contact information, and prices.

It is an object of the present invention for the system to have a nursery. The nursery is a place where a user can post pictures of newborn pets.

It is an object of the present invention for the system to have a section for groomers, where users are able to find groomers in their area.

It is an object of the present invention for the system to have search capabilities so that a user can search the site for anything pet related.

It is an object of the present invention for the system to provide real time notifications and alerts.

It is an object of the present invention for the system to provide a way so that the user sends messages to other users or has a chat room where users chat with other users.

It is an object of the present invention for the system to have a Youtube API integration.

It is an object of the present invention for the system to have a photo gallery of the pets of different users

It is an object of the present invention for the system to have a video gallery of the pets of different users.

It is an object of the present invention to have a program that provides a way to invite friends to the site.

It is an object of the present invention for a user to submit to the system a request for advertising. It is an object of the present invention for the system to provide an administrative control to place ads on any section of the site.

It is an object of the present invention for the site to have a groomers section, breeders section and veterinary section. It is an object of the present invention for the system to list groomers, breeders, and veterinarians and for a user to search for these persons and be able to be filter the list.

### BRIEF DESCRIPTION OF THE FIGURES

FIG. 1 shows a version of a main page of a site of the present invention.

FIG. 2 shows a page of a user being in the system of the present invention.

FIG. 3 shows an embodiment of a webpage for sharing and posting photos.

FIG. 4 shows an embodiment of a webpage for searching breeders by name and/or location.

FIG. 5 shows an embodiment of a webpage for searching doctors by name and/or location.

FIG. 6 shows an embodiment of a webpage for sharing and posting photos.

FIG. 7 shows an embodiment of a webpage of a town hall of the website of the present invention.

FIG. 8 shows an embodiment showing a registration process of the present invention.

FIG. 9 shows an embodiment of a webpage for a profile photo, liking and inviting friends.

FIG. 10 shows the system with an authenticated user section and an anonymous user section.

FIG. 11 shows a diagram showing different webpages and their different relationships.

### DETAILED DESCRIPTION OF THE INVENTION

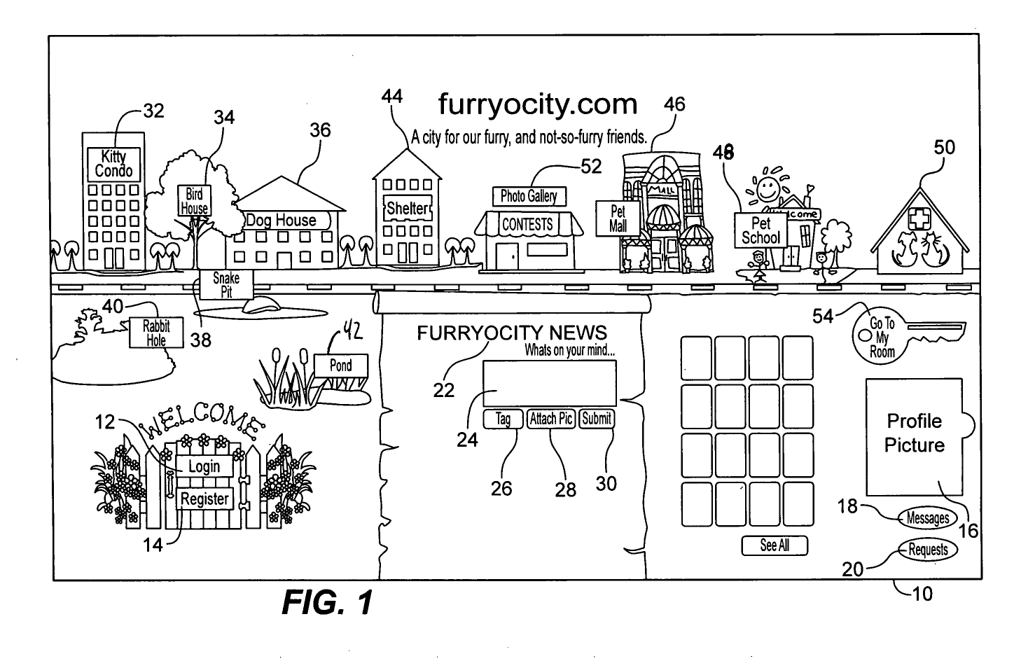

FIG. 1 shows a main screen 10 having a login 12 and a registration 14. The screen 10 further comprises a profile picture 16, a message link 18, and a request link 20. The screen 10 further comprises a news section 22 which allows a user to input information 24, tag 26, picture attachment 28, and submit function 30. The screen 10 further comprises houses and residences 32, 34, 36, 38, 40, 42, pet shelter 44, pet mall 46, pet school 48, and veterinary house 50. Screen 10 further comprises a place to hold contests 52 where users can submit photos. The screen 10 further comprises a link 54 where a user can enter their personal room.

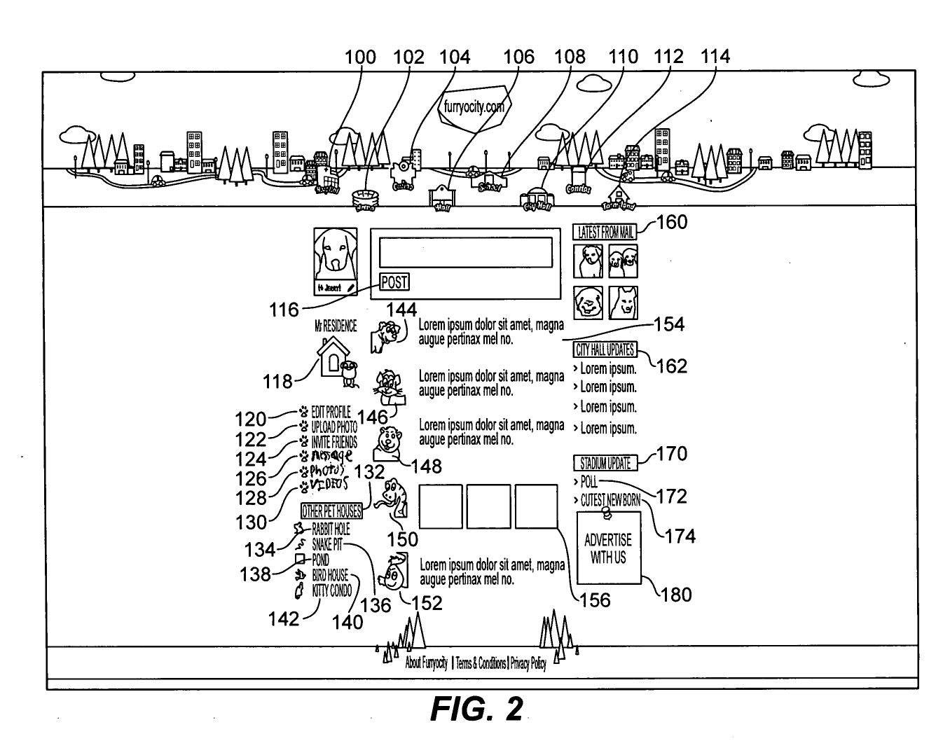

FIG. 2 shows the virtual city having a hospital 100, arena 102, casino 104, mall 106, school 108, city hall 110, condos 112, and farm land 114. On this page the user can post in writing to others the posts being 116. The page shows the residence 118 which is shown in FIG. 2 as a doghouse. The page further allows the user to edit their profile 120, upload a photo 122, invite friends 124, receive messages 126, receive photos 128 and receive videos 130. The system also provides views of other pet houses 132, such as rabbit hole 134, snake pit 136, pond 138, birdhouse 140 and kitty condo 142. There are different messages sent to the user along with an animated photo of the user sending the text message pictures or video. These animated photos are shown as photos 144, 146, 148, 150 and 152. The text messages are shown for example as 154 and the attached photos are shown as 156. The page also shows the latest information from the mall 160 and shows city hall updates 162. Further, the page also has information about stadium updates 170 which include polls 172 and the cutest newborn 174. Further, the page shows a place where the user can advertise 180 with the system of the invention.

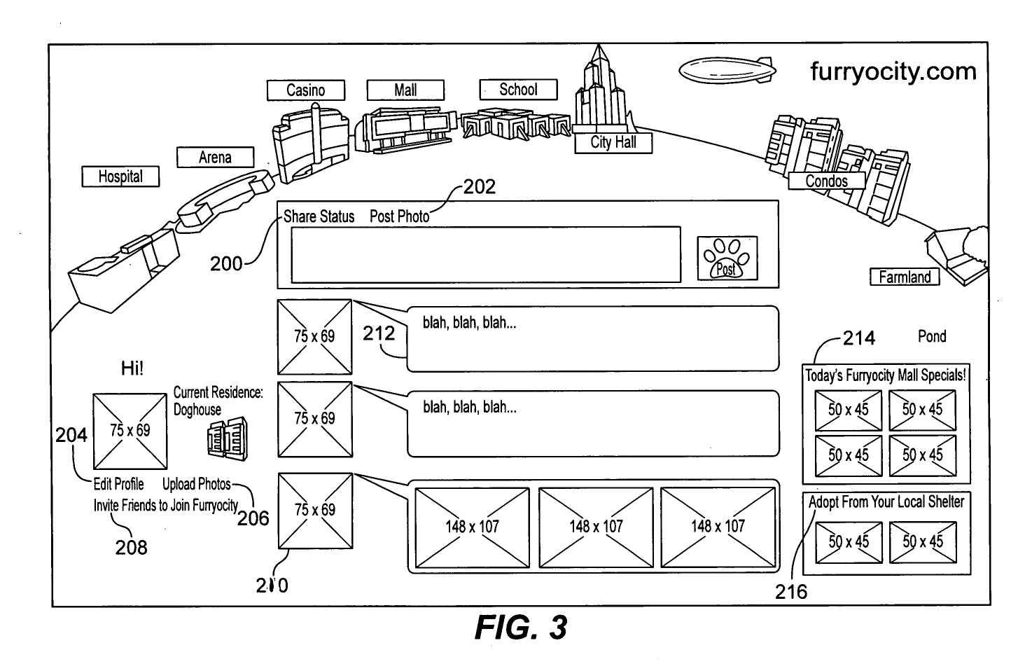

FIG. 3 shows a further page of a user of the present invention wherein the user can share status updates 200 or post a photo 202. The system provides on this page that the user can edit their profile 204, upload photos 206 and invite friends to join the site 208. On this page, the user can attach different size photos 210 with a text 212. The webpage further provides mall specials from the site 214 and pictures from the local shelter with regards to adoption 216.

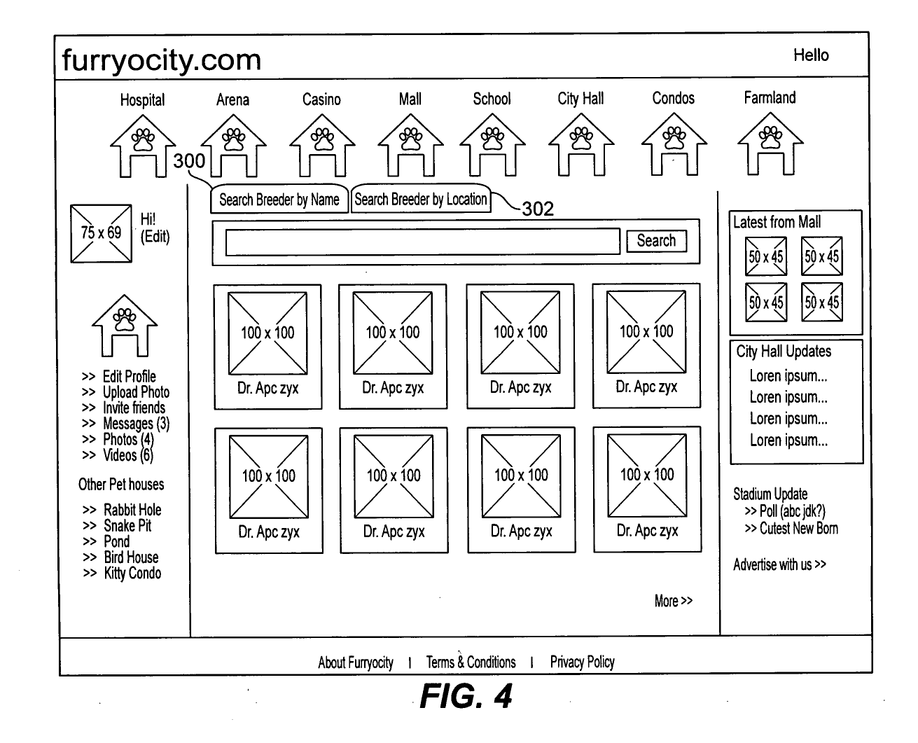

FIG. 4 shows a webpage wherein a user can search for a breeder by name 300 or search for a breeder by location 302.

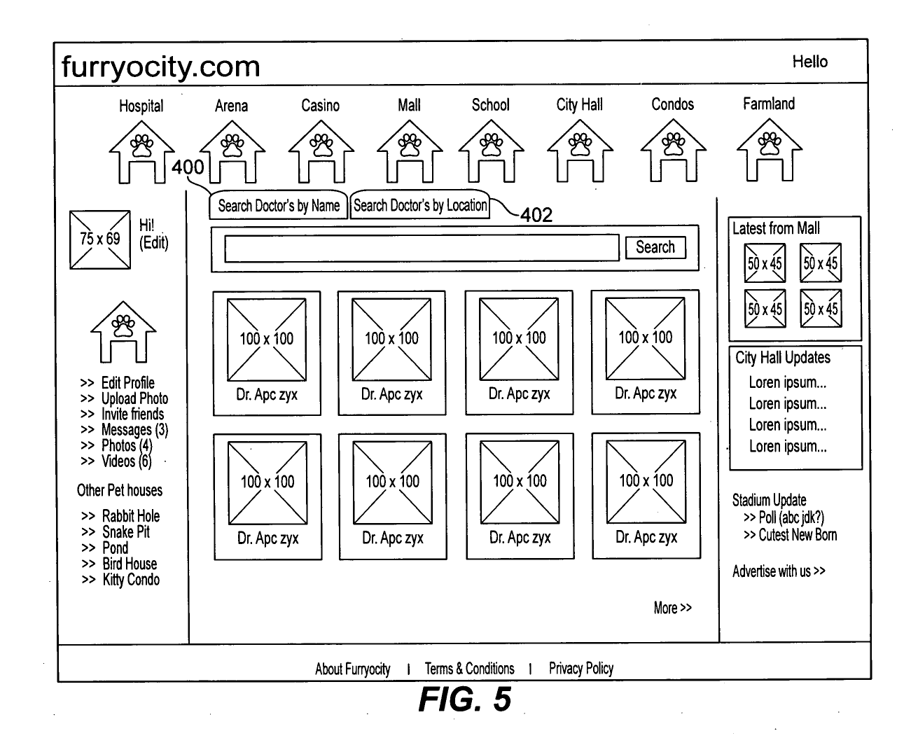

FIG. 5 is a further page of the system of the present invention which provides a way of searching for a doctor by name 400, and further provides a way of searching for a doctor by location 402.

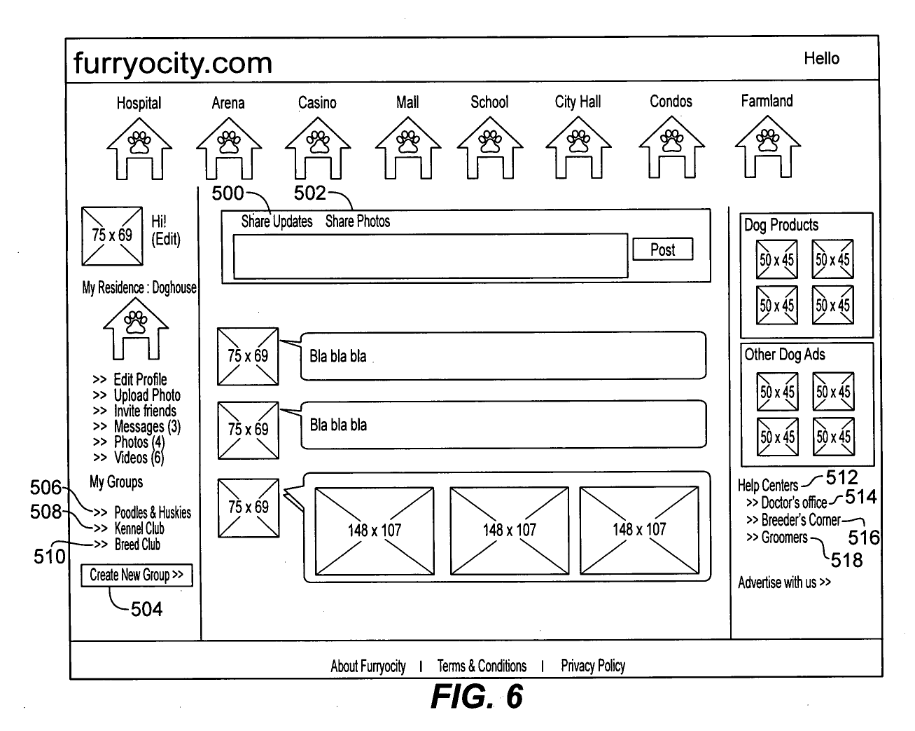

FIG. 6 shows a page from the system of the present invention which allows a user to share updates 500 and also to share photos 502. The webpage further provides a program to create new groups 504, for example poodles and huskies 506, the kennel club 508 and the breed club 510. The webpage further provides health centers 512, doctors office 514, breeders corner 516 and groomers 518.

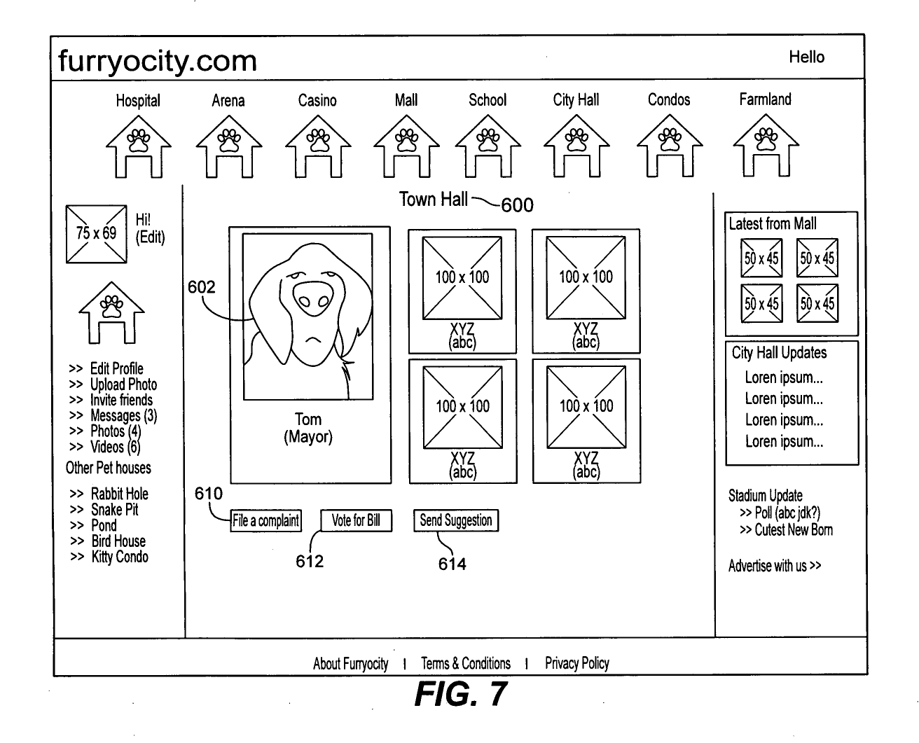

FIG. 7 shows the town hall page 600 having a photo of the mayor 602, town hall page 600 allows a user to file a complaint 610 to vote for the mayor 612 or to send a suggestion 614.

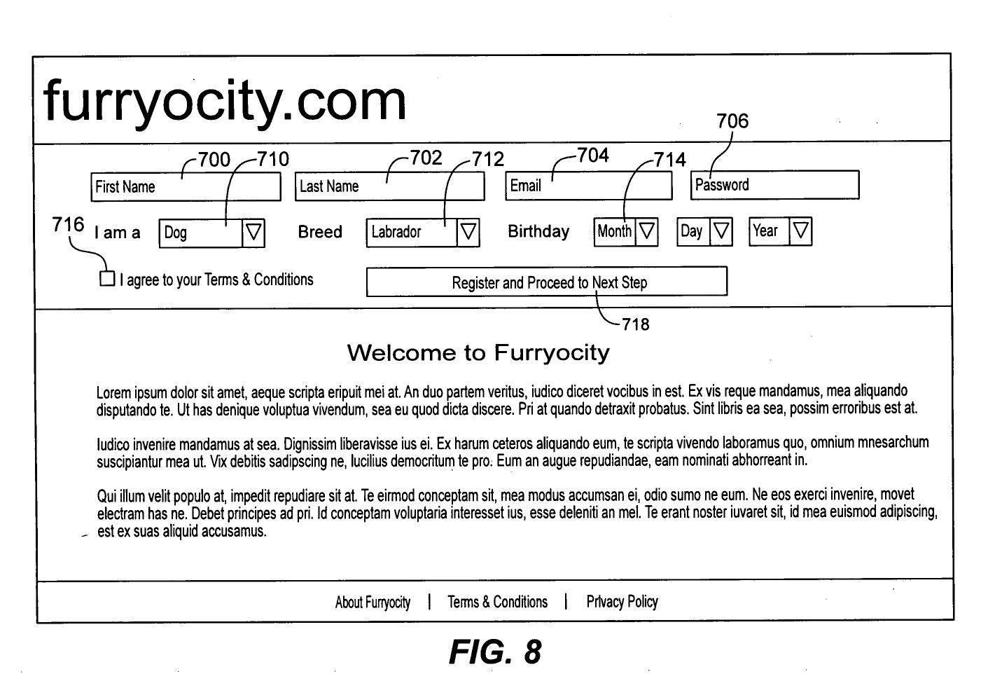

FIG. 8 shows a webpage showing how to register for the website. It includes a space 700 for a user to enter the first name of their pet, a space 702 for a user to enter the last name of their pet, a space to enter an email address 704, a space to enter a password 706, a space 710 in which a user can either enter the type of animal or have a dropdown menu for the user to choose the animal. The webpage further has a space 712 in which the user can either enter the type of animal or a drop down menu to choose the type of breed. The webpage further has spaces 714 in which a user can either enter or have a dropdown menu to enter the birthdate of the animal. There is a further box 716 in which a user must agree to the terms and conditions of the website and further there is a click on 718 wherein the user can register and proceed.

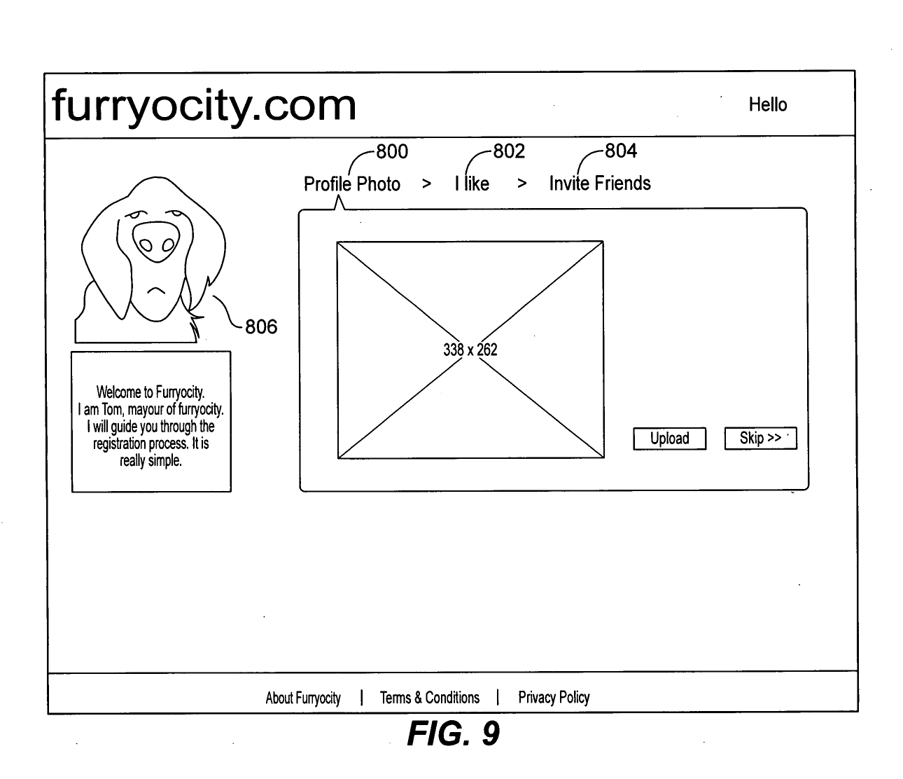

FIG. 9 shows the system providing a way to upload a profile photo 800, a way for a user to like another's photo or comment 802 and a further way to invite friends 804. The system also provides a guide 806 whether it be an actual photo or an animated photo of a pet that will then guide a user through the registration process.

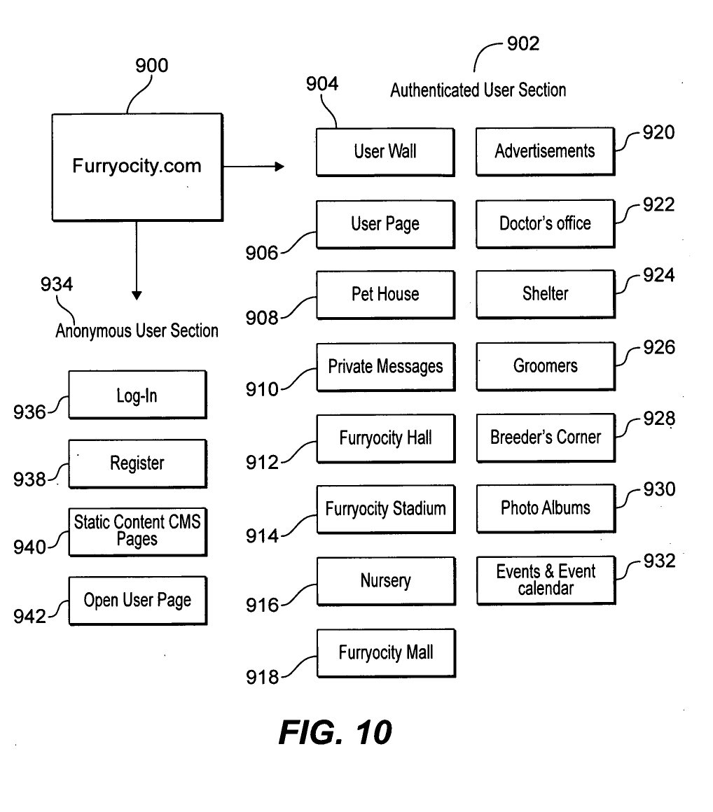

FIG. 10 shows the system 900 having an authenticated user section 902 that includes a user wall 904, user page 906, pet house 908, private messages 910, hall 912, Stadium 914, nursery 916, Mall 918, advertisements, 920, doctor's office 922, shelter 924, groomers 926, breeder's corner 928, photo albums 930, events and event calendar 932, also having an anonymous user section 934 that includes a log-in 936, register 938, static content CMS pages 940, and open user page 942.

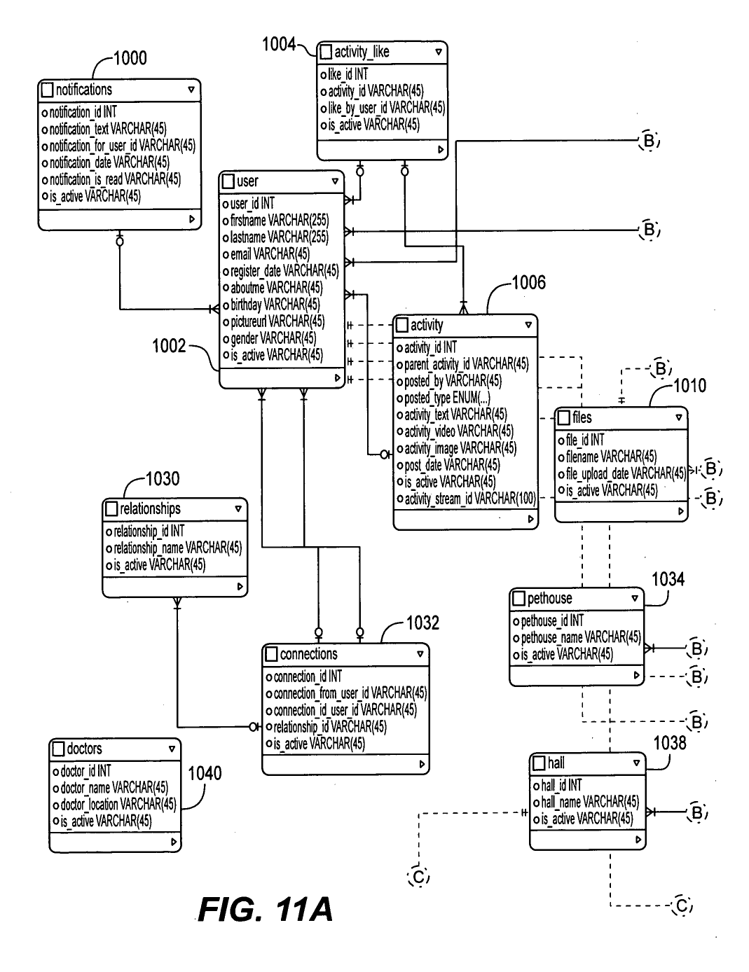

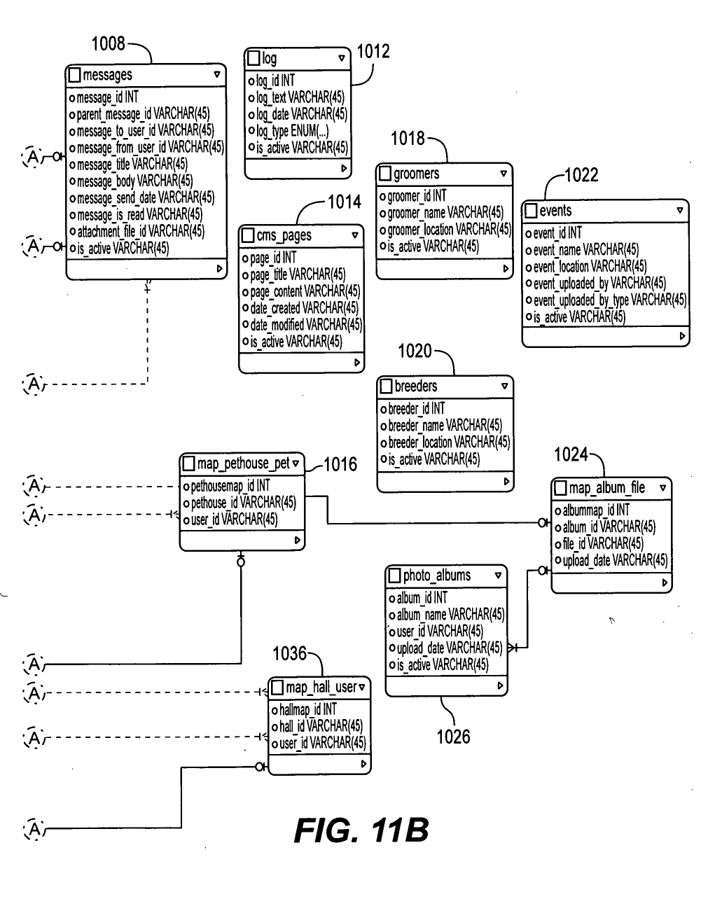

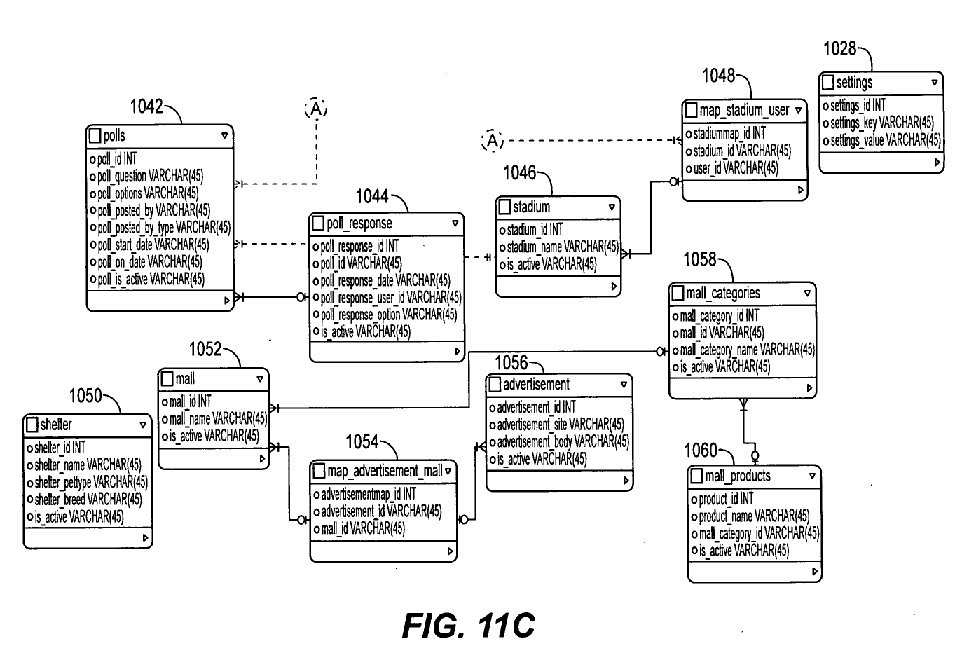

FIG. 11 shows the different web pages of the system and how they are interconnected. The following web pages include notifications 1000, user 1002, activity-like 1004, activity 1006, messages 1008, files 1010, log 1012, CMS-pages 1014, map-pet house-pet 1016, groomers 1018, breeders 1020, events 1022, map-album 1024, photo album 1026, settings 1028, relationships 1030, connections 1032, pet house 1034, map-hall-user 1036, hall 1038, doctors 1040, polls 1042, poll response 1044, stadium 1046, map-stadium-user 1048, shelter 1050, mall 1052, map-advertisement-mall 1054, advertisements 1056, mall categories 1058, mall products 1060.

1. A system that provides a social media site that caters to pet owners comprising:
a computer system wherein a user uploads photos and videos of a user's pets;
said system comprising images of advertiser's products and services related to pets;
said system providing products comprising pet supplies and pet services.

2. The system of claim 1 wherein said site is animated.

3. The system of claim 1 wherein said site includes stories about said user's pets.

4. The system of claim 1 further comprising a virtual city, having virtual buildings.

5. The system of claim 1 wherein a user logs onto said cite and explores various virtual buildings.

6. The system of claim 1 wherein said site contains a virtual veterinarian clinic that provides advice for users, provides medications, and provides referrals to veterinarians in their area.

7. The system of claim 1 wherein said site contains a virtual shelter where a user can adopt a pet.

8. The system of claim 1 wherein said site provides information regarding charitable institutions for users to donate to an animal charity.

9. The system of claim 1 wherein said system provides access for users to visit other pet owners in one of virtual housing units.

10. The system of claim 9 wherein said units house pet owners of dogs, cats, horses, reptiles, rodents or fish.

11. The system of claim 9 wherein said housing unit is a virtual dog house.

12. The system of claim 9 wherein said housing unit is a virtual stables.

13. The system of claim 9 wherein said housing unit is a pond.

14. The system of claim 9 wherein said virtual housing units comprise a virtual lobby serving as a central gathering place for all pets within a particular class.

15. The system of claim 1 further comprising a bulletin board where users see what all of their pets are up to.

16. The system of claim 1 further comprising a virtual mayor or mascot that assists a user in registration for said site, or finding anything on said site.

17. The system of claim 1 further comprising a program that allows said users to vote for different positions on said site, such as, mayors, or mascots, or a new functionality for said system.

18. The system of claim 1 further comprising a dictionary of terms and phrases unique to said system.

19. The system of claim 18 wherein said system engages with said users in suggesting words for said site dictionary.

20. The system of claim 1 further comprising a daily, weekly, monthly or annual contests.

21. The system of claim 1 wherein said system provides a currency that can only be spent on products and services provided by said system.

22. The system of claim 21 wherein said currency is spent at a virtual mall on said site, or donated to one of said charities on said site.

23. The system of claim 1 wherein said system provides pet insurance on said site.

24. A method for providing access to a social media website for pets comprising:
providing a password for a user;
creating a profile of a pet of said user;
providing information to said user regarding a registration process;
giving screen tips/hints as necessary;
choosing a pet type/residence;
entering information regarding said pet;
entering said email address of said user;
providing an agreement of acceptable terms to said user, that said user must agree with prior to being allowed on said site.

25. The method of claim 24 wherein a caricature of an actual pet provides said screen tips/hints.

26. The method of claim 24 wherein said information includes said pets birthday, a picture of said pet, favorite food, favorite toy, favorite activity.

27. The method of claim 26 wherein said information is used by marketing companies to provide directed advertising to said users.

28. The method of claim 24, wherein after registration said user is brought to a main page of said site having a virtual city comprising virtual buildings and stores.

29. The method of claim 24 further comprising:
providing a news feed that includes announcements and news articles.

30. The method of claim 24 further comprising:
displaying posts from said user's pet friends on announcements, or on a bulletin board for each residential building.

31. The system of claim 4 wherein said
buildings comprise a split screen that show a user's own virtual room and a virtual lobby of said building.

32. The system of claim 31 wherein said room looks like an actual room in an apartment complex, and said user customizes said room with pictures, wall colors and other personal items.

33. The system of claim 31 wherein said lobby of said building features a directory of users and shows which of said users are online.

34. The system of claim 4 further comprising a bulletin board where users interact with other residents of that building through status posts, picture posts, and comments.

35. The system of claim 1 further comprising a virtual mall that operates as a main sales page of said site.

36. The system of claim 35 wherein said virtual mall comprises store fronts and a directory of shops that are located throughout said mall.

37. The system of claim 1 further comprising a virtual shelter where a user can adopt a pet or donate to their favorite pet charity.

38. The system of claim 1 further comprising a virtual stadium; said virtual stadium comprising a contest section of said site.

39. The system of claim 1 further comprising a moving virtual blimp where advertisers display ads, and users enter a variety of picture and video contests.

40. The system of claim 1 further comprising a program where users report inappropriate conduct, and ask questions.

41. The system of claim 1 further comprising an area where breeders advertise pets they have for sale, and include information about animals credentials, awards, contact information, and prices.

42. The system of claim 1 further comprising a virtual nursery where a user posts pictures of newborn pets.

43. The system of claim 1 further comprising a section for groomers, where users find groomers in their area.

44. The system of claim 1 further comprising search capabilities so a user searches said site for anything pet related.
